(19) United States
(12) Patent Application Publication
(10) Pub. No.: US 2026/0312323 A1
(43) Pub. Date: Oct. 8, 2026

(54) ELECTRICAL CONTACT ELEMENT, PLUG CONNECTOR INSERT, AND MODULAR INDUSTRIAL PLUG CONNECTOR COMPRISING SAME

(71) Applicant: HARTING Electric Stiftung & Co. KG, Espelkamp (DE)

(72) Inventors: Albert FERDERER, Espelkamp (DE); Sebastian GRIEPENSTROH, Lübbecke (DE)

(21) Appl. No.: 19/108,302

(22) PCT Filed: Sep. 6, 2023
(86) PCT No.: PCT/DE2023/100658

§ 371 Date: Mar. 3, 2025

(30) Foreign Application Priority Data
Sep. 23, 2022 (DE) 10 2022 124 488.1

(51) Int. Cl. H01R 13/424

(52) U.S. Cl. CPC H01R 13/424

(57) ABSTRACT

The invention relates to an electrical contact element to be deployed in a modular industrial plug connector that has a plug connector housing made of metal, said contact element comprising a contact region and a fastening region, wherein the fastening region, in order to fasten the contact element to the plug connector housing, comprises a securing opening for receiving a fastening means. A plug connector insert for a modular industrial plug connector is designed to receive such a contact element. A modular industrial plug connector comprises such a plug connector insert.

### DESCRIPTION

The invention relates to an electrical contact element for use in a modular industrial plug connector which has a plug connector housing made of metal, a plug connector insert with such a contact element and a modular industrial plug connector with such a plug connector insert.

### PRIOR ART

Thanks to their modular design, modular industrial plug connectors can be flexibly adapted to specific requirements in terms of signal and power transmission, e.g., between two electrical devices. For this purpose, plug connector modules are usually inserted into corresponding holding frames, which are sometimes also referred to as hinged frames, module frames or modular frames, thereby forming plug connector inserts. The holding frames are thus used to hold several plug connector modules that are similar and/or different to each other and to securely fasten them to a surface and/or a device wall and/or in a plug connector housing or similar. However, such holding frames require additional space in the industrial plug connector, and so their use in particularly compact industrial plug connectors is undesirable.

With modular plug connectors, plug connector modules are used to flexibly adapt a plug connector, in particular a heavy industrial plug connector, to specific requirements regarding signal and power transmission, e.g., between two electrical devices. For this purpose, plug connector modules are usually inserted into corresponding holding frames, which are sometimes also referred to as hinged frames, module frames or modular frames. The holding frames are thus used to hold several plug connector modules that are similar and/or different to each other and to securely fasten them to a surface and/or a device wall and/or in a plug connector housing or similar. Plug connector modules can be made up of two different functional units.

Plug connector housings can be made of different materials, such as various plastics or metal. If a plug connector housing is made of metal, it requires a contact to a protective earth conductor for safety reasons for many applications. For this purpose, industrial plug connectors that have a holding frame are provided with plug connector modules that have an electrical connection to the holding frame and are connected to a protective earth conductor. The holding frame in turn has an electrical connection to the plug connector housing.

The German Patent and Trademark Office has searched the following prior art in the priority application for the present application: DE 102015 122 195 A1.

### STATEMENT OF PROBLEM

Against this background, the invention solves the problem of simplifying the use of metal plug connector housings for compact modular industrial plug connectors.

The problem is solved by a contact element according to claim 1, a plug connector insert according to claim 4 and an industrial plug connector according to claim 8. Advantageous embodiments are the subject of the dependent claims.

The problem is solved, for example, by an electrical contact element for use in a modular industrial plug connector which has a plug connector housing made of metal, wherein the contact element has a contact area and a fixing area, wherein the fixing area for fixing the contact element to the plug connector housing has a fastening opening for receiving a fixing means.

By fixing the contact element directly to the plug connector housing, this makes it possible to electrically connect the contact element to the metal plug connector housing in a compact way. By dispensing with a mounting cage or holding frame, a very compact design can be achieved.

In further embodiments, the contact area is designed to accommodate and/or make contact with a second contact element.

This allows the potential of the protective earth conductor to be passed on to another industrial plug connector.

In further embodiments, the contact element has a connection area for connecting an electrical conductor.

This makes it easy to connect a protective earth conductor to the contact element.

The problem is furthermore solved by a plug connector insert for use in a modular industrial plug connector, having at least a first functional unit and a second functional unit, wherein the first functional unit is designed to receive a contact element according to one of the preceding claims.

This allows a compact plug connector insert to be constructed for use in metal plug connector housings.

In further embodiments, the first functional unit at least partially encloses the contact element and thereby fixes it relative to the plug connector insert, wherein the first functional unit comprises a feed-through opening for feeding through the fixing means and/or the contact element, which is arranged and/or shaped such that a portion of the contact element and/or the fixing means forms an electrical contact with the plug connector housing when installed in the plug connector housing.

This ensures that the arrangement of the contact element and the plug connector insert in the plug connector housing is particularly secure and at the same time ensures a secure electrical connection between the contact element and the plug connector housing.

In further embodiments, the functional units have fastening means molded onto one another for mutual fastening, which are arranged in a manner complementary to one another.

By fixing the functional units together, the plug connector insert as a whole can also be fixed in the plug connector housing using the fixing means. As additional frame elements can therefore be dispensed with, a particularly compact design is achieved.

In some embodiments, at least two, in particular all, contact elements of the functional unit have a connection area of the same design.

This simplifies the setup of the functional unit, as the connection of the contact elements with cables is the same for several or all contact elements and can therefore be easily trained and carried out quickly and thoroughly as a routine activity.

The problem is further solved by a modular industrial plug connector which has a plug connector insert according to one of claims 4 to 7, wherein, when connected to another industrial plug connector of this kind, the plug connector housings of the two industrial plug connectors are electrically connected to one another by means of the contact elements.

This makes it possible to create a particularly compact modular industrial plug connector that enables the use of a metal plug connector housing in a compact way.

The functional units each have holding means molded onto them. The holding means protrude from the narrow sides and are rectangular or cuboid in shape. In the case of functional units assembled to form a plug connector module, the holding means are accommodated in the recesses of the above-mentioned holding frame. To insert the plug connector modules, the holding frame is unfolded, i.e., opened, wherein the frame halves are only unfolded about the joints to the extent that the plug connector modules can be inserted. The frame halves are then snapped together, i.e., the holding frame is closed, wherein the holding means enter the recesses and the plug connector modules are held securely and form-fittingly in the holding frame.

The functional units shown here can be used individually or combined to form a plug connector module and fixed in a holding frame in an industrial plug connector of different sizes.

### EXEMPLARY EMBODIMENT

An exemplary embodiment of the invention is shown in the drawings and is explained in greater detail below; in the drawings:

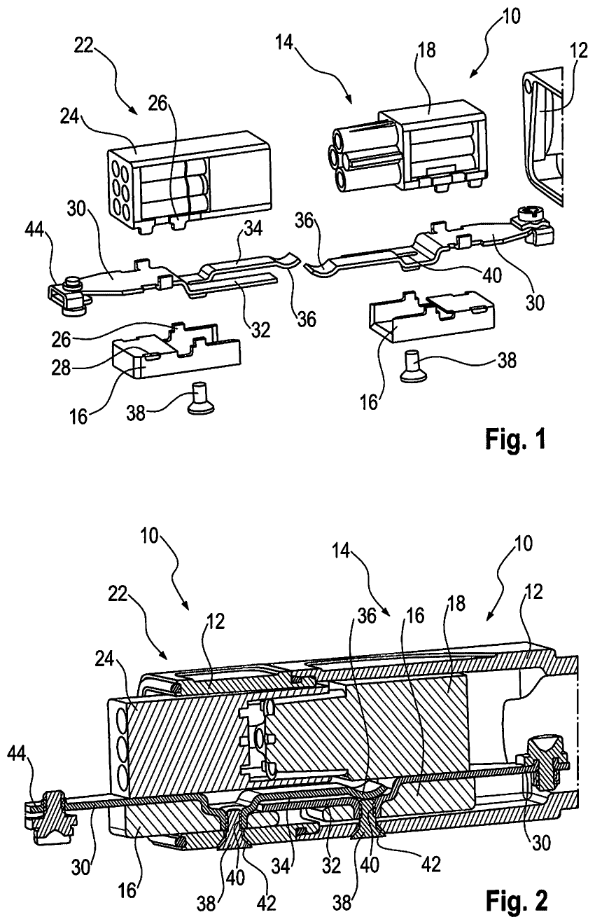

FIG. 1 shows an exploded view of two complementary industrial plug connectors with plug connector inserts and contact elements;

FIG. 2 shows a sectional view of the industrial plug connectors from FIG. 1 in assembled and nested form, and

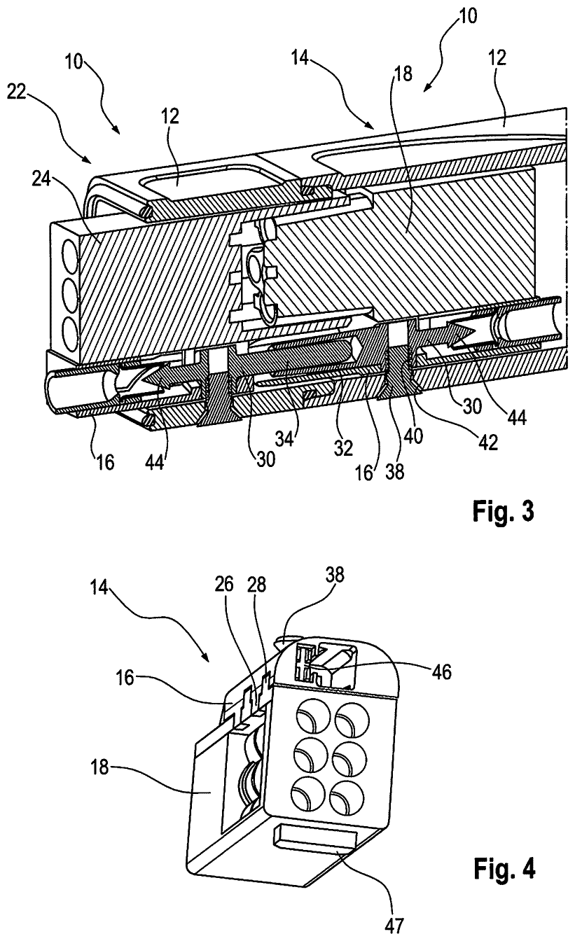

FIG. 3 shows a sectional view of two industrial plug connectors similar to FIG. 2 with an alternative design of the contact elements, and

FIG. 4 shows a 3D view of interconnected plug connector inserts.

Some of the figures contain simplified, schematic representations. In some cases, identical reference signs are used for like but possibly non-identical elements. Different views of the same elements may be scaled differently. Directional indications such as “left”, “right”, “top” and “bottom” are to be understood with reference to the respective figure and may vary in the individual illustrations in relation to the object shown.

An industrial plug connector 10 shown in FIG. 1 has a plug connector housing 12 and a first plug connector insert 14. The plug connector insert 14 has a first functional unit 16 and a second functional unit 18.

A plug connector housing 12 (not shown) and a second plug connector insert 22 are provided to form an industrial plug connector 10. The second plug connector insert 22 has a first functional unit 16 and a second functional unit 24.

The second functional unit 18 of the plug connector insert 14 and the second functional unit 24 of the plug connector insert 22 are designed in such a way that one of the functional units 18, 24 can be accommodated by the other. This is achieved, for example, by fitting shapes and/or slightly inclined guide walls. The functional units 18, 24 can also be designed to be torsion-resistant, for example due to their shape.

The first functional units 16 and the second functional units 18, 24 can be fastened to one another by means of fastening means, which are designed, for example, as lugs 26 or receptacles 28. The lugs 26 and the receptacles 28 can form a snap connection with each other, for example.

Contact elements 30 can be inserted into the first functional units 16. Fixing means 38 are provided for fastening the contact elements 30 to the first functional units 16 and/or to the respective plug connector housing 12. To receive the fixing means 38 in the contact elements 30, a receiving opening is provided in a fixing area 40 of the contact elements 30. If the fixing means 38 is a screw, for example, a thread can be provided in the receiving opening, for example. Feed-through openings are provided in each of the first functional units 16, through which the fixing means 38 can be guided.

In order to define the arrangement of the contact element 30, the first functional unit 16 surrounds the contact element 30 on one side. In addition, the first functional unit 16 rests against at least some surfaces of the contact element 30.

The contact elements 30 each have one or more contact areas 32, 34. The contact areas 32, 34 are designed in such a way that, when two contact elements 30 are arranged opposite one another and with the contact areas 32, 34 pointing towards one another, a contact area 32 of one of the contact elements 30 is in contact with a contact area 34 of the contact element 30 arranged opposite. For this purpose, the contact areas 32, 34 are designed, for example, as two tabs pointing in the mating direction and arranged offset to one another, wherein one of the contact areas 34 has a contact tip 36 which extends towards the contact area 32 of the opposite contact element 30 and makes contact with it. As a result, the tabs 32, 34 of the respective contact elements 30 interlock, as can be seen in FIG. 2, for example.

To form the plug connector insert 14, the contact element 30 is inserted into the first functional unit 16 in a first step and, in a second step, the first functional unit 16 is attached to the second functional unit 18 by means of the tabs 26 and/or receptacles 28. If the second functional unit 18 requires contact elements and/or socket elements, for example, these can be inserted in a third step. The third step can, for example, also be carried out before the first step.

To form the industrial plug connector 10, the plug connector insert 14 is inserted into the plug connector housing 12 in a first step and, in a second step, the contact element 30 is fixed in place by means of the fixing means 38.

A connection area 44 is provided for the connection of conductors, which can be of different designs. One type is formed in each case by the way in which the conductor is fastened to the connection area 44.

Two fully assembled industrial plug connectors 10 plugged into one another are shown in FIG. 2. The second functional units 18, 24 are shown plugged into one another, as are the plug connector housings 12. The fixing means 38 are each guided through fastening openings 42 in the plug connector housings 12.

In some embodiments, the contact elements 30 have a substantially cylindrical or prismatic contact portion in their fixing area 40, which contact portion extends along the fixing means 38 to the plug connector housing 12 and effects a direct connection between the contact element 30 and the plug connector housing 12. At the same time, an arrangement of the contact areas 32, 34 relative to the plug connector housing 12 can be defined by means of the contact portion. Each of the contact areas 32, 34 is therefore electrically connected directly to the plug connector housing 12 via a contact portion of its respective contact element 30. In addition, it is possible, for example, to prevent the first functional unit 16 from being damaged by tightening the fixing means 38 too tightly.

In order to facilitate the contacting of the plug connector housing 12 with the contact element 30, the plug connector housing 12 can have an unpainted or paint-free surface portion for contacting the fixing area 40, in particular the contact portion.

The further embodiment of the industrial plug connector 10 shown in FIG. 3 differs substantially from the previous embodiment in the way in which the contact elements 30 are formed at their contact areas 32, 34. The contact area 34 is designed as a pin, for which the contact area 32 provides a receptacle which, for example, has the shape of a hollow cone at least in portions.

In addition, the contact elements 30 differ from the previously shown embodiments in the design of the connection areas 44. For example, the contact elements 30 have a quick-release fastener 44 for connecting the contact elements 30 to cables made of fine stranded wire (“quick-lock”).

In further embodiments, the quick-release fastener 44 can also have an axially acting spring into which a conductor can be inserted (“push-in”). A plug connector insert 14 for receiving a contact element 30 designed in this way is shown in FIG. 4. A holding edge of the spring holds and contacts the inserted conductor. The connection thus formed can be released by pressing in a release device 46.

The shape of the contact areas 32, 34 and a connection area for connection to cables, for example the quick-release fastener 44, are independent of each other and can be combined as desired.

In some embodiments, the contact elements 30 may, for example, be formed as a stamped-and-bent part, for example also integrally together with the first functional unit 16. In this case, the fastening means 26, 28 for fastening to the second functional unit 18, 24 may also, for example, be formed integrally with the contact element 30 on the first functional unit 16.

In addition to the embodiment shown here, the fastening means 26, 28 can form any desired snap-in connection for connecting the functional units 16, 18, 24. Such latching connections can be realized in an extremely compact manner and still ensure a high-quality fixation of the functional units 16, 18, 24 to each other.

The present invention allows a simple feed-through of a protective earth conductor and earthing of a plug connector housing 12 made of metal in a compact design.

### LIST OF REFERENCE SIGNS

10 industrial plug connector
12 plug connector housing
14 plug connector insert
16 first functional unit
18 second functional unit
22 plug connector insert
24 second functional unit
26 fastening means (tab)
28 fastening means (receptacle)
30 contact element
32 contact region
34 contact region
36 contact tip
38 fixing means
40 fixing area
42 fastening opening (of the plug connector housing 12)
44 connection area (quick-release fastener)
46 release device
47 holding means

1. An electrical contact element (30) for use in a modular industrial plug connector (10) which has a plug connector housing (12) made of metal, wherein the contact element (30) has a contact area (32, 34) and a fixing area (40), wherein the fixing area (40) for fixing the contact element (30) to the plug connector housing (12) has a fastening opening for receiving a fixing means (38).

2. The contact element (30) as claimed in claim 1, characterized in that the contact region (32, 34) is designed to receive and/or contact a second contact element (30).

3. The contact element (30) as claimed in claim 1, characterized by a connection area for connecting an electrical conductor.

4. A plug connector insert (14, 22) for use in a modular industrial plug connector, having at least a first functional unit (16) and a second functional unit (18, 24), characterized in that the first functional unit (16) is designed to receive a contact element (30) as claimed in claim 1.

5. The plug connector insert (14, 22) as claimed in claim 4, characterized in that the first functional unit (16) at least partially encloses the contact element (30) and thereby fixes it relative to the plug connector insert (14, 22), wherein the first functional unit (16) comprises a feed-through opening for feeding through the fixing means (38) and/or the contact element (30), which is arranged and/or shaped such that a portion of the contact element (30) and/or the fixing means (38) forms an electrical contact with the plug connector housing (12) when installed in the plug connector housing (12).

6. The plug connector insert as claimed in claim characterized in that the functional units (16, 18, 24) have fastening means (26, 28) molded onto one another for mutual fastening, which are arranged in a manner complementary to one another.

7. The plug connector insert as claimed in claim 4, characterized in that at least two, in particular all, contact elements (30) of the functional units (16, 18, 24) have a connection area of the same design.

8. A modular industrial plug connector (10), characterized by a plug connector insert (14, 22) as claimed in claim 4, wherein, when connected to another industrial plug connector (10) of this kind, the plug connector housings (12) of the two industrial plug connectors (10) are electrically connected to one another by means of the contact elements (30).
